(19) United States
(12) Patent Application Publication
(10) Pub. No.: US 2025/0175408 A1
(43) Pub. Date: May 29, 2025

(54) CONTROLLER AREA NETWORK SYSTEM TESTING EQUIPMENT AND METHODS

(71) Applicant: Schlumberger Technology Corporation, Sugar Land, TX (US)

(72) Inventors: Limin Chen, Houston, TX (US); Dinesh Kumar Dhamodaran, Coimbatore (IN); Vikas Rakhunde, Katy, TX (US); Dinesh Prabhu Nataraja Prabu, Coimbatore (IN); Sathish Kumar Saravanan, Coimbatore (IN); Suryanarayanaa Vijayasai, Coimbatore (IN)

(21) Appl. No.: 18/963,313

(22) Filed: Nov. 27, 2024

(30) Foreign Application Priority Data
Nov. 28, 2023 (IN) 202311080522

(51) Int. Cl. H04L 43/50; H04L 12/40

(52) U.S. Cl. CPC H04L 43/50; H04L 12/40; H04L 2012/40215

(57) ABSTRACT

A system includes an interconnection terminal box connected to a plurality of core components in an integrated system. Through disconnection of one or more core components of the plurality of core components from the interconnection terminal box, the system is configured to individually test a at least one core component of the plurality of core components that remains connected to the interconnection terminal box, and through connection of the plurality of core components to the interconnection terminal box, the system is configured to test the integrated system as a whole.

### CROSS-REFERENCE TO RELATED APPLICATION

This application claims benefit to Indian Provisional Patent Application No. 202311080522, filed Nov. 28, 2023, which is incorporated by reference herein in its entirety.

### BACKGROUND

Controller area network (CAN) is an electronic communication bus system utilized in automobile and automation control systems connecting industrial electronics devices. Systems utilizing CAN technology often need to be tested during the development or manufacturing phase to ensure proper functionality and configuration of the devices and systems before delivery. Depending on the system setup, sometimes the cost to establish such a test bench could be high due time consumption and hardware complexity. Accordingly, there is a need for testing systems and methods that simplify the testing process and increase flexibility with respect to CAN system verification and validation.

### SUMMARY

A system according to one or more embodiments of the present disclosure includes an interconnection terminal box connected to a plurality of core components in an integrated system. Through disconnection of one or more core components of the plurality of core components from the interconnection terminal box, the system is configured to individually test at least one core component of the plurality of core components that remains connected to the interconnection terminal box. Through connection of the plurality of core components to the interconnection terminal box, the system is configured to test the integrated system as a whole.

A system according to one or more embodiments of the present disclosure includes: a power transformer; a converter configured to transform an alternating current voltage input from the power transformer into a direct current voltage; a modem; a central processing unit (CPU); a controller area network (CAN) module, wherein the direct current voltage output from the converter is configured to power the modem; the CPU; and the CAN module, wherein each of the modem and the CAN module is configured to communicate with the CPU; an ethernet switch configured to communicate with the CPU; a user device configured to communicate with the ethernet switch; an interconnection terminal box, wherein the interconnection terminal box is configured to receive power from at least one of: the power transformer; and the converter, and wherein the interconnection terminal box is configured to communicate with at least one of: the modem; the CPU; and the CAN module; at least one core component for testing selected from the group consisting of: a top side control panel; a subsea electronic module (SEM); a pressure transducer module (PTM); a solenoid valve module (SVM); and a riser control box (RCB), wherein the top side control panel is configured to communicate with the modem, and wherein each of the SEM, the PTM, the SVM, and the RCB is configured to receive power and communication through the interconnection terminal box.

A method according to one or more embodiments of the present disclosure includes connecting a plurality of core components to an interconnection terminal box in an integrated system; isolating at least one core component of the plurality of core components for testing; and testing the isolated at least one core component.

A system according to one or more embodiments of the present disclosure includes a power transformer; a converter configured to transform an alternating current voltage input from the power transformer into a direct current voltage; a modem; a central processing unit (CPU); a controller area network (CAN) module, wherein the direct current voltage output from the converter is configured to power the modem; the CPU; and the CAN module, wherein each of the modem and the CAN module is configured to communicate with the CPU; an ethernet switch configured to communicate with the CPU; a user device configured to communicate with the ethernet switch; a pressure transducer module (PTM); and a Drilling Solenoid Driver Module (DSDM), wherein each of the PTM and the DSDM communicates with the CAN module via a CAN network to provide CAN device node identification programming capability to the system.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 shows a conceptual, schematic view of a control system for a drilling rig, according to one or more embodiments of the present disclosure;

FIG. 2 shows a conceptual, schematic view of the control system shown in FIG. 1, according to one or more embodiments of the present disclosure;

FIG. 3 shows a schematic view of a wellsite, according to one or more embodiments of the present disclosure;

FIG. 4 shows an architecture of core components according to one or more embodiments of the present disclosure;

FIG. 5 shows a scenario of testing a standalone solenoid valve module (SVM) and/or a pressure transducer module (PTM) according to one or more embodiments of the present disclosure;

FIG. 6 shows a scenario of testing a standalone subsea electronic module (SEM) according to one or more embodiments of the present disclosure;

FIG. 7 shows a scenario of testing a top side control system according to one or more embodiments of the present disclosure;

FIG. 8 shows a scenario of testing a standalone riser control box (RCB) according to one or more embodiments of the present disclosure;

FIG. 9 shows a scenario of testing the SVM/PTM with the SEM and/or the RCB presented as the integration test according to one or more embodiments of the present disclosure; and

FIG. 10 shows a scenario as a programmer for the CAN device node ID change according to one or more embodiments of the present disclosure.

### DETAILED DESCRIPTION

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

In the specification and appended claims, the terms “connect,” “connection,” “connected,” “in connection with,” and “connecting,” are used to mean “in direct connection with,” or “in connection with via one or more elements.” The terms “couple,” “coupled,” “coupled with,” “coupled together,” and “coupling” are used to mean “directly coupled together,” or “coupled together via one or more elements.” The term “set” is used to mean setting “one element” or “more than one element.” As used herein, the terms “up” and “down,” “upper” and “lower,” “upwardly” and “downwardly,” “upstream” and “downstream,” “uphole” and “downhole,” “above” and “below,” “top” and “bottom,” and other like terms indicating relative positions above or below a given point or element are used in this description to more clearly describe some embodiments of the disclosure. Commonly, these terms relate to a reference point at the surface from which drilling operations are initiated as being the top point and the total depth being the lowest point, wherein the well (e.g., wellbore, borehole) is vertical, horizontal, or slanted relative to the surface.

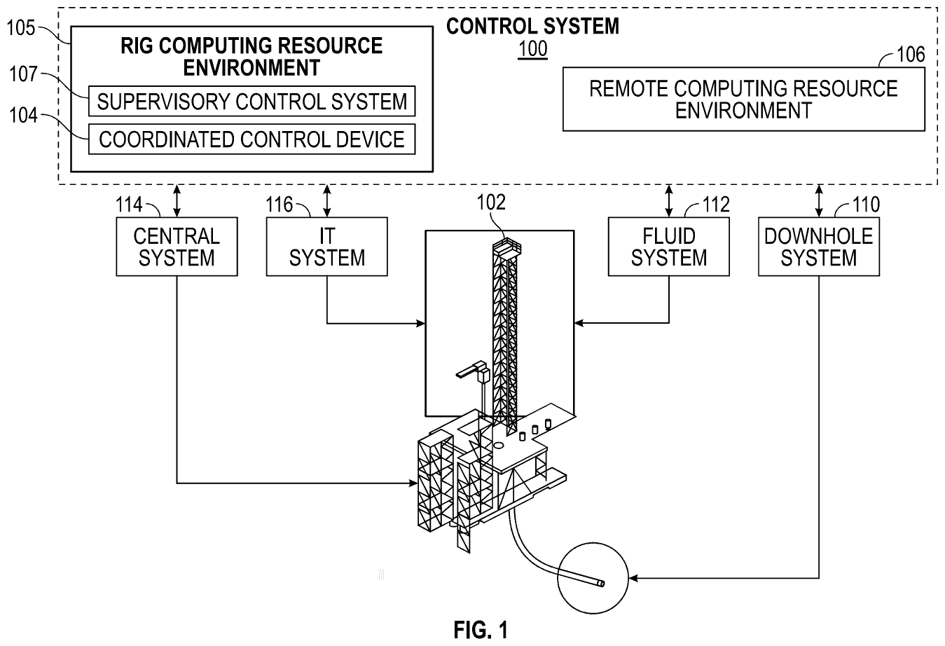

FIG. 1 shows a conceptual, schematic view of a control system 100 for a drilling rig 102, according to one or more embodiments of the present disclosure. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

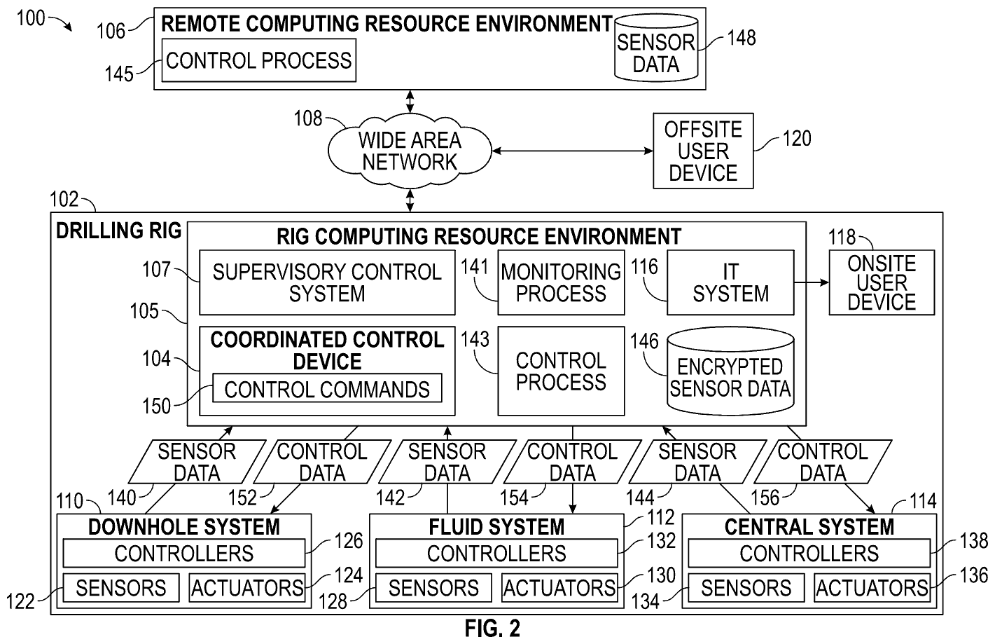

FIG. 2 shows a conceptual, schematic view of the control system 100 shown in FIG. 1, according to one or more embodiments of the present disclosure. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g., tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration.

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

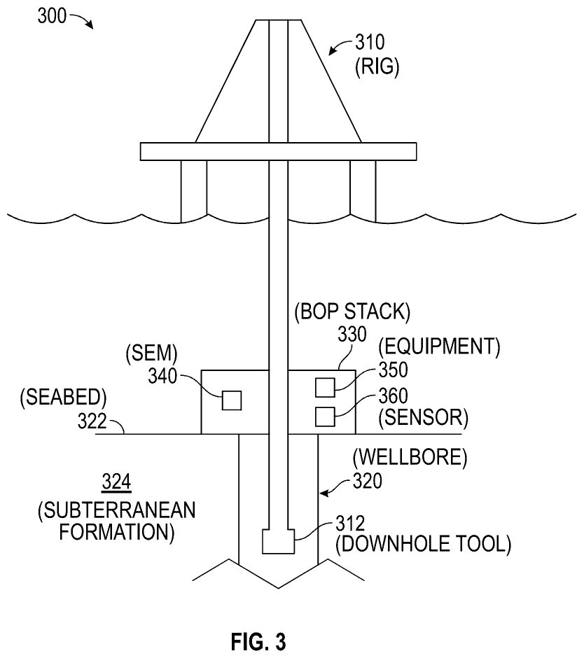

FIG. 3 shows a schematic view of a wellsite 300, according to an embodiment. The wellsite 300 may be on land or subsea. The wellsite 300 may include a drilling rig 310 positioned over a wellbore 320. As shown, the drilling rig 310 may control a downhole tool 312 that drills the wellbore 320 through a seabed 322 and down into a subterranean formation 324 therebelow.

The wellsite 300 may also include a blowout preventer (BOP) stack 330 positioned above or at least partially within the wellbore 320. The BOP stack 330 may provide pressure control for the wellbore 320.

The wellsite 300 may also include a subsea electronic module (SEM) 340. The SEM 340 may be connected to the BOP stack 330. The SEM 340 may communicate with one or more programmable logic controllers (e.g., described below). For example, the SEM 340 may transmit a status (e.g., position or state) of equipment (e.g., a subsea valve) to a surface PLC. In another example, the SEM 340 may receive instructions (e.g., a valve command) to actuate the equipment.

The wellsite 300 may also include equipment 350. The equipment 350 may be connected to and/or positioned on/within the drilling rig 310, the wellbore 320, the BOP stack 330, the SEM 340, or a combination thereof. The equipment 350 may be or include an actuator configured to actuate between at least a first position or state and a second position or state. More particularly, the equipment 350 may be or include a switch or a valve (e.g., a solenoid valve) in/on the BOP stack 330. In another embodiment, the equipment 350 may be or include a CAN-compatible actuator such as a motor, a motor driver, a driver system, a CAN-based sensor, or a combination thereof. A system for controlling equipment 350 at a wellsite 300 that leverages a CAN network is provided in U.S. Pat. No. 11,824,682, which is incorporated by reference herein in its entirety.

The wellsite 300 may also include one or more sensors (one is shown: 360). The sensor 360 may be connected to and/or positioned at least partially on/within the wellbore 320, the BOP stack 330, the SEM 340, the equipment 350, or a combination thereof. The sensor 360 may be configured to sense (e.g., measure or monitor) one or more parameters in/of the wellbore 320, the BOP stack 330, the SEM 340, the equipment 350, or a combination thereof. The parameters may be or include temperature, pressure, trajectory, resistivity, porosity, sonic velocity, gamma ray, power (e.g., voltage and/or current), position/state (e.g., of the switch or valve), or a combination thereof.

### CAN System Testing Equipment and Methods

The subsea drilling BOP is a critical safety equipment that is utilized for pressure control in the well drilling process. The BOP control system, which is referred to as a drilling pod, usually includes hydraulic valves to control the pilot pressure that drives the BOP stack valve (RAM) and pressure transducers that are used for some key pressure monitoring. The typical way to control the pilot valve is an electrical solenoid valve module (SVM). Further, the pressure transducers are normally built as a pressure transducer module (PTM) in the array format. The communication to the SVM and PTM are through the CAN.

It is critical to test the control pod thoroughly during the manufacturing and system integration phase to ensure the proper functionality and configuration of the SVMs and PTMs before the delivery to the rig. The traditional way to test the control pod is to wait for all the components of the pod to be completed before the test can be performed because only then the SVM can be functioned through the subsea electronic module (SEM). This sometimes results in delays and increased costs if issues are found after everything is completed and right before delivery. One or more embodiments of the present disclosure tackles such issues by providing multiple testing function roles in the pod test process so that the manufacturing or testing team can have the flexibility to test the partial system earlier in the assembly phase to verify all the components and subsystem before the integration test.

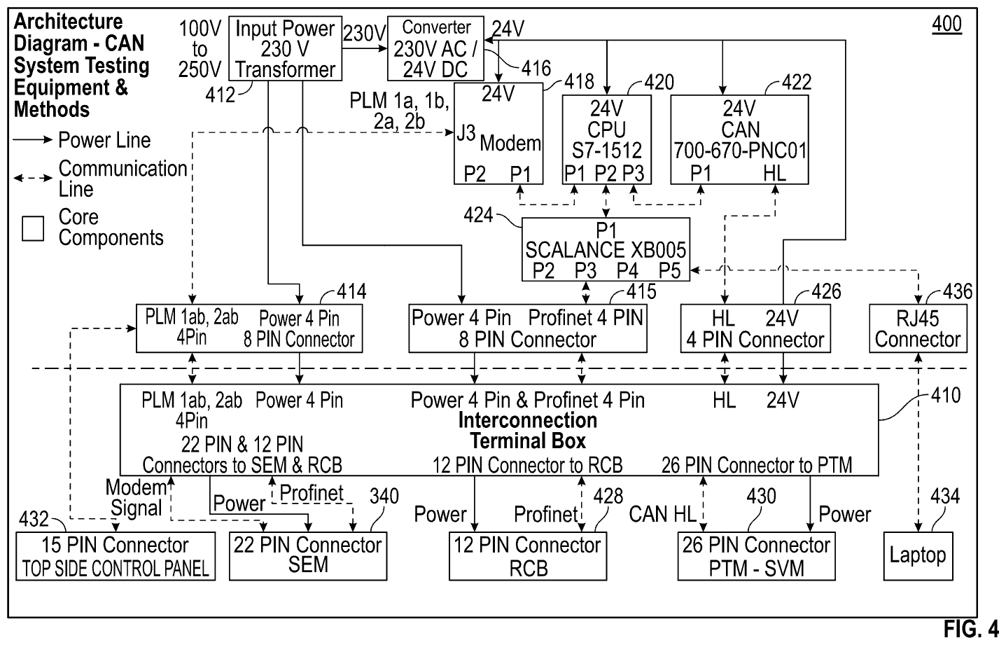

Referring now to FIG. 4, an architecture of core components according to one or more embodiments of the present disclosure is shown. For example, the system 400 may include an interconnection terminal box 410, according to one or more embodiments of the present disclosure. As shown in FIG. 4, the interconnection terminal box 410 is configured to receive power from a transformer 412 via connectors 414, 415 which may be 8 pin connectors, for example. According to one or more embodiments of the present disclosure, the transformer 412 may be configured to supply power to a converter 416 based on voltage in a range of 100V to 250V. For example, as shown in FIG. 4, the converter 416 may be configured to convert 230V of AC power from the transformer 412 into 24V of DC power, for supply to other core components of the system 400. For example, the converter 416 may be configured to supply DC power to one or more of a modem 418, a central processing unit (CPU) 420, and a CAN module 422. As also shown in FIG. 4, the converter 416 may be configured to supply DC power to the interconnection terminal box 410 via a connector 426, which may be a 4 pin connector, for example.

Still referring to FIG. 4, the system according to one or more embodiments of the present disclosure may also include an industrial ethernet switch 424. According to one or more embodiments of the present disclosure, the CPU 420 and the modem 418 may be configured to communicate with each other, the CPU 420 and the CAN module 422 may be configured to communicate with each other, and the CPU 420 and the industrial ethernet switch 424 may be configured to communicate with each other. As further shown in FIG. 4, for example, the modem 418 and the interconnection terminal box 410 may be configured to communicate with each other through connector 414. Likewise, the industrial ethernet switch 424 and the interconnection terminal box 410 may be configured to communicate with each other through connector 415. The CAN module 422 and the interconnection terminal box 410 may be configured to communicate with each other through connector 426, for example.

Still referring to FIG. 4, the interconnection terminal box 410 may be configured to supply power to an SEM 340, a riser control box (RCB) 428, and a PTM-SVM 430 according to one or more embodiments of the present disclosure. As also shown in FIG. 4, the interconnection terminal box 410 and the SEM 340 may be configured to communicate with each other via a modem signal or a Profinet protocol, for example. The interconnection terminal box 410 and the RCB 428 may be configured to communicate with each other via a Profinet protocol, for example. The interconnection terminal box 410 may be configured to communicate with each other via a CAN network, for example.

Still referring to FIG. 4, the system 400 may also include a top side control panel 432, for example. According to one or more embodiments of the present disclosure, the modem 418 and the top side control panel 432 may be configured to communicate with each other through connector 414, for example. The system 400 according to one or more embodiments of the present disclosure may also include a laptop 434 (or another user device). The industrial ethernet switch 424 and the laptop 434 are configured to communicate with each other via a connector 436, such as a Registered Jack-45 connector 436, for example.

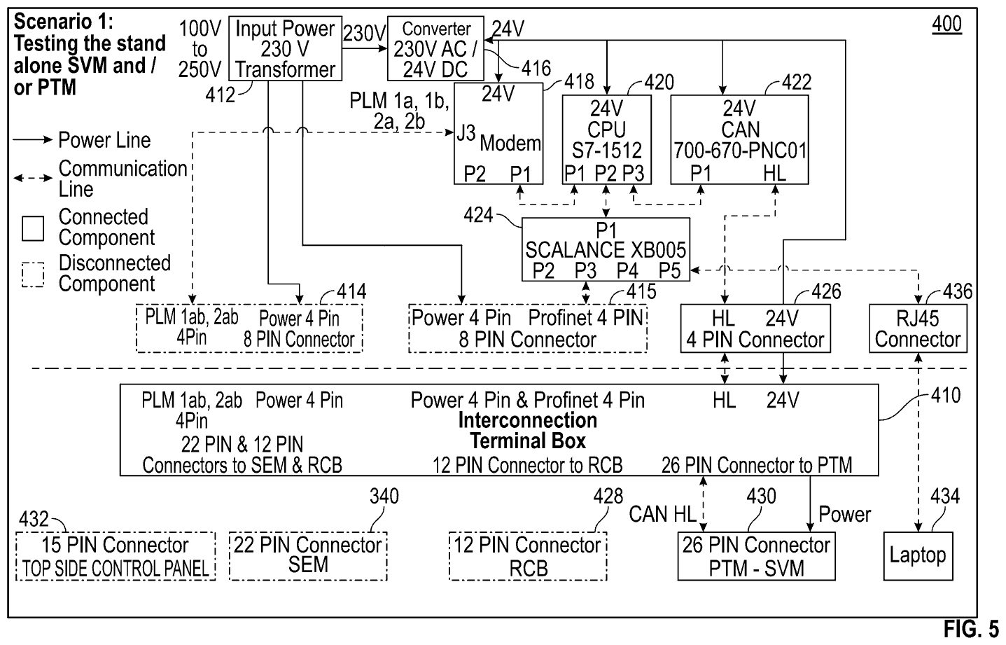

One or more embodiments of the present disclosure provides multiple hardwiring interfaces with configurable software, which may be used to test a partially completed device or subsystem individually. For example, FIGS. 5-9 show scenarios for testing one or more partially completed devices or subsystems of the system 400 by connecting those partially completed devices or subsystems and associated core components within the system 400 and disconnecting those core components that are not currently being tested from the system 400. As further shown in FIGS. 5-9, certain core components of the system 400 may remain connected within the system 400 during testing, regardless of the partially completed device or subsystem being tested, including, for example, transformer 412, converter 416, modem 418, CPU 420, CAN module 422, industrial ethernet switch 424, connector 436, and laptop 434, according to one or more embodiments of the present disclosure.

For example, FIG. 5 shows a scenario in which the system 400 according to one or more embodiments of the present disclosure provides the capability to test the PTM-SVM 430 (i.e., the PTM and/or the SVM) before the SEM 340 or the RCB 428 is ready. Indeed, in the system 400 shown in FIG. 5, for example, core components including connectors 414, 415, topside control panel 432, SEM 340 and RCB 428 have been disconnected from the interconnection terminal box 410, and only PTM-SVM 430 and associated core components through connector 426 are connected to the interconnection terminal box 410. As further shown in FIG. 5, during testing of the PTM-SVM 430, communication to the PTM-SVM 430 is facilitated through the CAN module 422, according to one or more embodiments of the present disclosure. With this configuration of system 400, PTM-SVM 430 (i.e., the PTM and/or the SVM) may be tested individually as a subsystem, and before other core components are ready, instead of being tested within the system 400 as a whole.

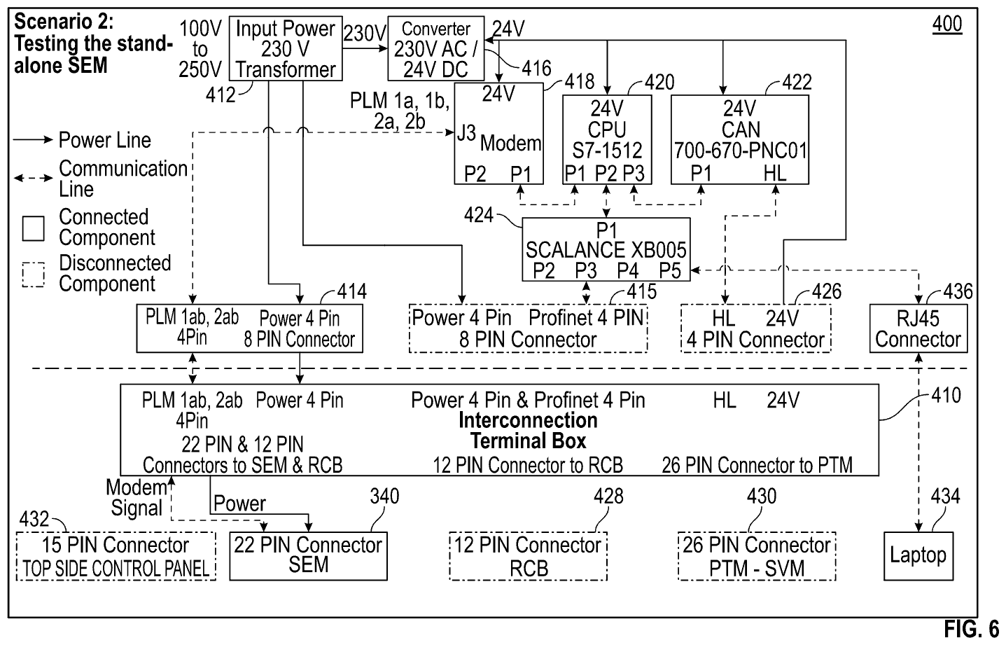

Further, FIG. 6 shows a scenario in which the system 400 according to one or more embodiments of the present disclosure provides the capability to test the SEM 340 as a partially completed device or subsystem individually from the whole of the system 400. Indeed, in the system 400 shown in FIG. 6, for example, core components including connector 415, connector 426, top side control panel 432, RCB 428, and PTM-SVM 430 have been disconnected from the interconnection terminal box 410, and only SEM 340 and associated core components through connector 414 are connected to the interconnection terminal box 410. As further shown in FIG. 6, during testing of the SEM 340, communication to the SEM 340 is facilitated via a modem signal from modem 418, according to one or more embodiments of the present disclosure. With this configuration of system 400, SEM 340 may be tested individually as a standalone subsystem, and before other core components are ready, instead of being tested within the system 400 as a whole.

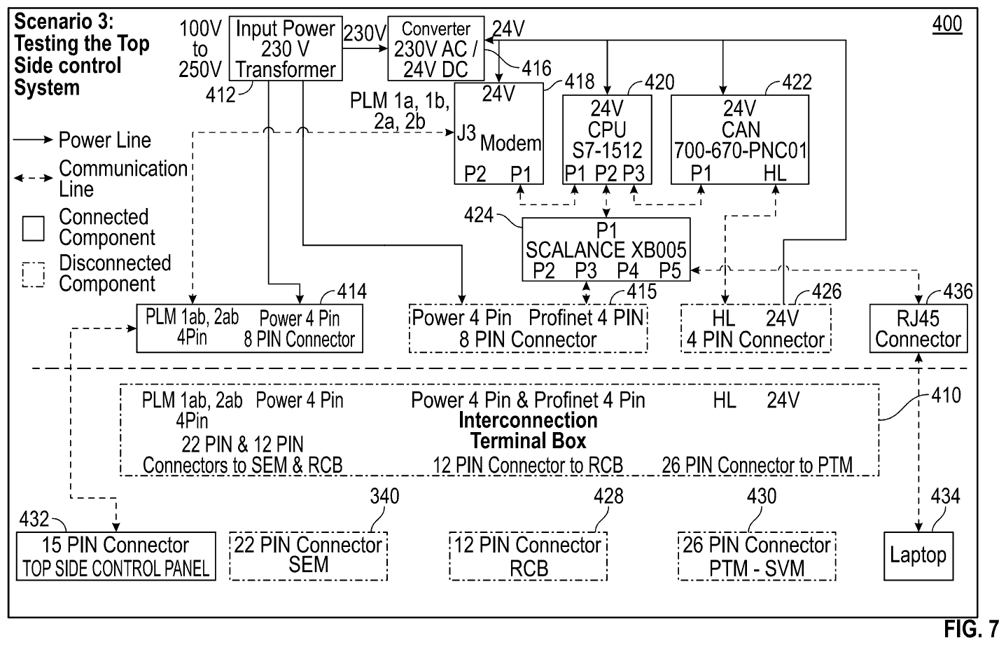

Further, FIG. 7 shows a scenario in which the system 400 according to one or more embodiments of the present disclosure provides the capability to test the top side control panel 432 as a partially completed device or subsystem individually from the whole of the system 400. Indeed, in the system 400 shown in FIG. 7, for example, core components including connector 415, connector 426, interconnection terminal box 410, SEM 340, RCB 428, and PTM-SVM 430 have been disconnected from the system 400, and only top side control panel 432 and associated core components of system 400 are connected within the system 400, according to one or more embodiments of the present disclosure. As further shown in FIG. 7, during testing of the top side control panel 432, communication to the top side control panel 432 is facilitated through modem 418 via connector 414, according to one or more embodiments of the present disclosure. With this configuration of system 400, top side control panel 432 may be tested individually as a subsystem, and before other core components are ready, instead of being tested within the system 400 as a whole.

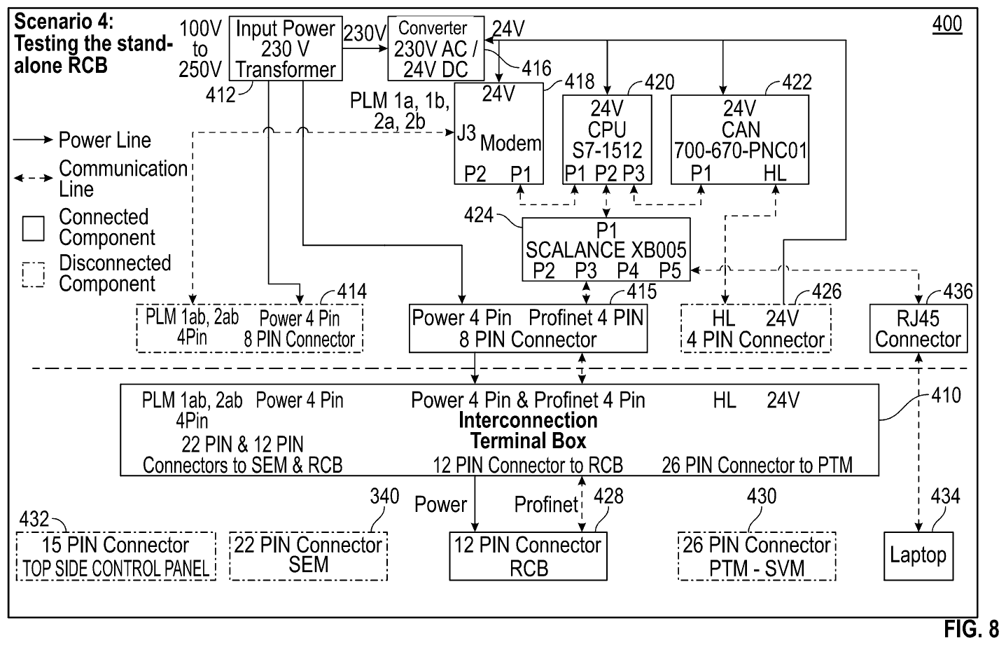

Further, FIG. 8 shows a scenario in which the system 400 according to one or more embodiments of the present disclosure provides the capability to test the RCB 428 as a partially completed device or subsystem individually from the whole of the system 400. Indeed, in the system 400 shown in FIG. 8, for example, core components including connector 414, connector 426, top side control panel 432, SEM 340, and PTM-SVM 430 have been disconnected from the interconnection terminal box 410, and only the RCB 428 and associated core components through connector 415 are connected to the interconnection terminal box 410. As further shown in FIG. 8, during testing of the RCB 428, communication to the RCB 428 is facilitated through the interconnection terminal box 410 via a Profinet protocol, according to one or more embodiments of the present disclosure. With this configuration of system 400, the RCB 428 may be tested individually as a standalone subsystem, and before other core components are ready, instead of being tested within the system 400 as a whole.

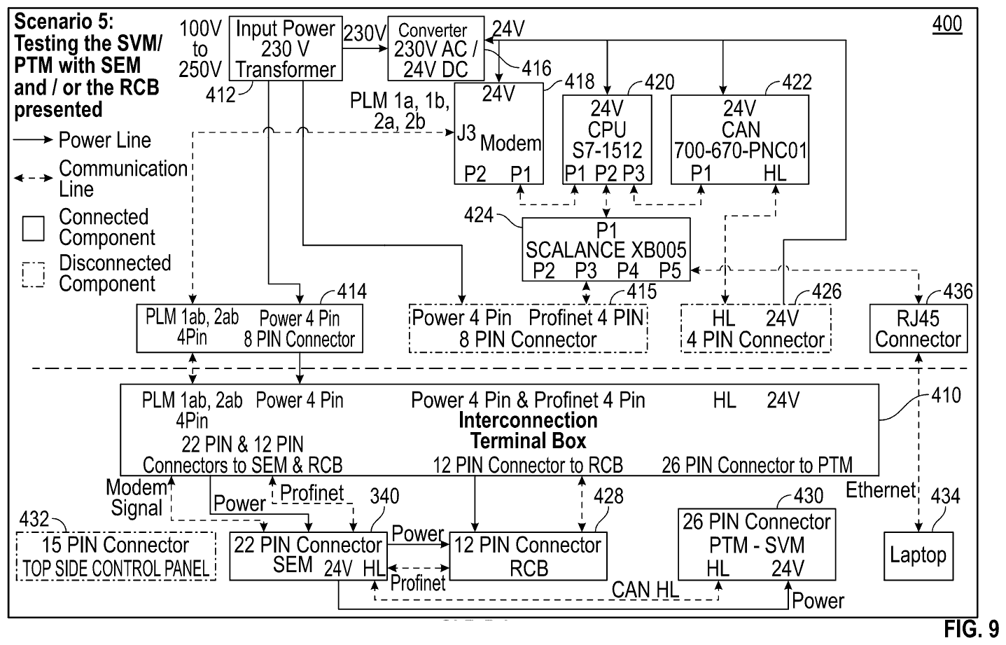

Further, FIG. 9 shows a scenario in which the system 400 according to one or more embodiments of the present disclosure provides the capability to test the PTM-SVM 430 with the SEM 340 and/or the RCB 428 presented. Indeed, in the system 400 shown in FIG. 9, for example, core components including connector 415, connector 426 and top side control panel 432 have been disconnected from the interconnection terminal box 410, and the PTM-SVM 430, the RCB 428, and the SEM 340 are connected to the interconnection terminal box 410 in order to test these core components of the system 400. Also during the testing scenario shown in FIG. 9, the interconnection terminal box 410 is connected to other connected core components of the system 400 via connector 414, according to one or more embodiments of the present disclosure. FIG. 9 also shows that the SEM 340 is connected to the interconnection terminal box 410 via a power line with communication between the SEM 340 and the interconnection terminal box 410 being facilitated by a modem signal from modem 418 and/or a Profinet protocol, according to one or more embodiments of the present disclosure. FIG. 9 also shows that the RCB 428 is connected to the SEM 340 via a power line with communication between the RCB 428 and the SEM 340 being facilitated by a Profinet protocol, according to one or more embodiments of the present disclosure. During this testing scenario, FIG. 9 also shows that the RCB 428 is connected to the interconnection terminal box 410 via the SEM 340, according to one or more embodiments of the present disclosure. FIG. 9 also shows that the PTM-SVM 430 is connected to the SEM 340 via a power line with communication between the PTM-SVM 430 and the SEM 340 being facilitated via a CAN network, according to one or more embodiments of the present disclosure. While FIG. 9 shows that each of the SEM 340, the RCB 428, and the PTM-SVM 430 is connected within the system 400 for testing together during the same testing scenario, the RCB 428 may be disconnected from the SEM 340 with the PTM-SVM 430 remaining connected to the SEM 340 in order for the PTM-SVM 430 and the SEM 340 to be tested together, or the PTM-SVM 430 may be disconnected from the SEM 340 with the RCB 428 remaining connected to the SEM 340 in order for the RCB 428 and the SEM 340 to be tested together, without departing from the scope of the present disclosure.

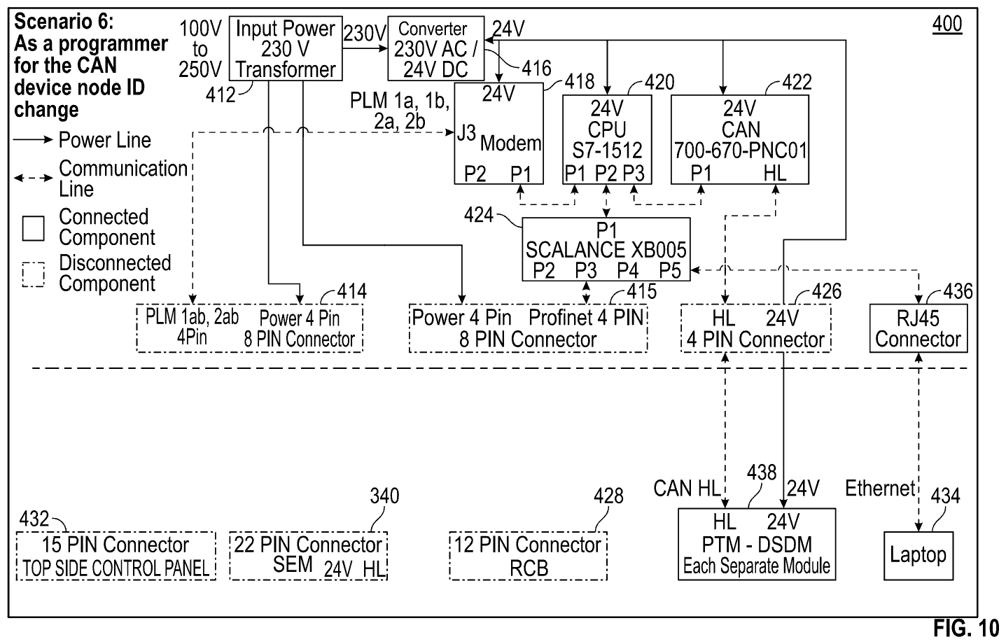

Referring now to FIG. 10, a scenario as a programmer for the CAN device node ID change is shown, according to one or more embodiments of the present disclosure. As shown in FIG. 10, the interconnection terminal box 410 has been removed, and the connector 414, the connector 415, the top side control panel 432, the SEM 340, and the RCB 428 have been disconnected. As further shown in FIG. 10, the PTM-SVM 430 has been replaced with a PTM-DSDM 438, according to one or more embodiments of the present disclosure. In system 400 according to one or more embodiments of the present disclosure, the PTM-DSDM 438 (i.e., the PTM and/or the DSDM, or Drilling Solenoid Driver Module) may be connected to CAN module 422 through connector 426 via a CAN network. According to one or more embodiments of the present disclosure, the PTM and the DSDM of the PTM-DSDM 438 may be separate modules without departing from the scope of the present disclosure. With this configuration, the system 400 according to one or more embodiments of the present disclosure provides CAN device node ID programming capability.

According to one or more embodiments of the present disclosure, a human machine interface (HMI) configures the test system to be a specific test role for the pod in software configuration including: a) CAN slave device Node ID programming, b) Individual DSDM or PTM functional testing, or c) POD communication and functional testing. The HMI also contains the testing interface for each solenoid of the valve and pressure transducer, according to one or more embodiments of the present disclosure.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system comprising:
an interconnection terminal box connected to a plurality of core components in an integrated system,
wherein through disconnection of one or more core components of the plurality of core components from the interconnection terminal box, the system is configured to individually test at least one core component of the plurality of core components that remains connected to the interconnection terminal box, and
wherein through connection of the plurality of core components to the interconnection terminal box, the system is configured to test the integrated system as a whole.

2. The system of claim 1, wherein the plurality of core components comprises:
a power transformer configured to connect to the interconnection terminal box;
a converter configured to transform an alternating current voltage input from the power transformer into a direct current voltage;
a modem;
a central processing unit (CPU);
a controller area network (CAN) module,
wherein the direct current voltage output from the converter is configured to power the modem; the CPU; and the CAN module,
wherein the modem is configured to communicate with the CPU, and
wherein the CAN module is configured to communicate with the CPU; and
an ethernet switch configured to communicate with the CPU and the interconnection terminal box.

3. The system of claim 2, further comprising: a user device,
wherein the user device is configured to communicate with the ethernet switch.

4. The system of claim 3, wherein the user device comprises a laptop.

5. The system of claim 3, wherein the at least one core component of the plurality of core components that remains to connected to the interconnection terminal box for testing comprises a pressure transducer module (PTM).

6. The system of claim 3, wherein the at least one core component of the plurality of core components that remains connected to the interconnection terminal box for testing comprises a solenoid valve module (SVM).

7. The system of claim 5, wherein the at least one core component of the plurality of core components that remains connected to the interconnection terminal box for testing further comprises a SVM.

8. The system of claim 3, wherein the at least one core component of the plurality of core components that remains connected to the interconnection terminal box for testing comprises a subsea electronic module (SEM).

9. The system of claim 3, wherein the at least one core component of the plurality of core components that remains connected to the interconnection terminal box for testing comprises a riser control box (RCB).

10. A system, comprising:
a power transformer;
a converter configured to transform an alternating current voltage input from the power transformer into a direct current voltage;
a modem;
a central processing unit (CPU);
a controller area network (CAN) module,
wherein the direct current voltage output from the converter is configured to power the modem; the CPU; and the CAN module,
wherein each of the modem and the CAN module is configured to communicate with the CPU;
an ethernet switch configured to communicate with the CPU;
a user device configured to communicate with the ethernet switch;
an interconnection terminal box,
wherein the interconnection terminal box is configured to receive power from at least one of: the power transformer; and the converter, and
wherein the interconnection terminal box is configured to communicate with at least one of: the modem; the CPU; and the CAN module;
at least one core component for testing selected from the group consisting of: a top side control panel; subsea electronic module (SEM); a pressure transducer module (PTM); a solenoid valve module (SVM); and a riser control box (RCB),
wherein the top side control panel is configured to communicate with the modem, and
wherein each of the SEM, the PTM, the SVM, and the RCB is configured to receive power and communication through the interconnection terminal box.

11. The system of claim 10, wherein, during testing of at least one of the PTM and the SVM:
each of the SEM and the RCB is disconnected from the interconnection terminal box; and
the top side control panel is disconnected from the modem.

12. The system of claim 10, wherein, during testing of the SEM:
each of the RCB, the PTM, and the SVM is disconnected from the interconnection terminal box; and
the top side control panel is disconnected from the modem.

13. The system of claim 10, wherein, during testing of the top side control panel:
each of the SEM; the RCB; the PTM; and the SVM is disconnected from the interconnection terminal box.

14. The system of claim 10, wherein, during testing of the RCB:
each of the SEM; the PTM; and the SVM is disconnected from the interconnection terminal box; and
the topside control panel is disconnected from the modem.

15. The system of claim 10, wherein, during testing of at least one of the SEM; the RCM; the PTM; and the SVM:
the top side control panel is disconnected from the modem.

16. The system of claim 10, wherein at least one of the SEM and the RCB is configured to communicate with the interconnection terminal box via a Profinet protocol.

17. The system of claim 10, wherein at least one of the PTM and the SVM is configured to communicate with the interconnection terminal box via a CAN network.

18. A method comprising:
connecting a plurality of core components to an interconnection terminal box in an integrated system;
isolating at least one core component of the plurality of core components for testing; and
testing the isolated at least one core component.

19. The method of claim 18, further comprising, testing the integrated system as a whole after testing the isolated at least one core component.

20. The method of claim 18, wherein the isolating step comprises disconnecting all core components of the plurality of core components from the interconnection terminal box except for the at least one core component of the plurality of core components being tested.

21. A system, comprising:
a power transformer;
a converter configured to transform an alternating current voltage input from the power transformer into a direct current voltage;
a modem;
a central processing unit (CPU);
a controller area network (CAN) module,
wherein the direct current voltage output from the converter is configured to power the modem; the CPU; and the CAN module,
wherein each of the modem and the CAN module is configured to communicate with the CPU;
an ethernet switch configured to communicate with the CPU;
a user device configured to communicate with the ethernet switch;
a pressure transducer module (PTM); and
a Drilling Solenoid Driver Module (DSDM):
wherein each of the PTM and the DSDM communicates with the CAN module via a CAN network to provide CAN device node identification programming capability to the system.
